(19) United States
(12) Patent Application Publication
(10) Pub. No.: US 2011/0106419 A1
(43) Pub. Date: May 5, 2011

(54) METHODS FOR REDUCING THE CONSUMPTION AND COST OF FUEL

(75) Inventor: Dae Sik Kim, Seoul (KR)

(73) Assignees: HYUNDAI MOTOR COMPANY, Seoul (KR); KIA MOTORS CORPORATION, Seoul (KR)

(21) Appl. No.: 12/786,866

(22) Filed: May 25, 2010

(30) Foreign Application Priority Data
Nov. 2, 2009 (KR) 10-2009-0104910

(51) Int. Cl. G01C 21/34; G06F 17/10

(52) U.S. Cl. 701/200; 703/2

(57) ABSTRACT

The present invention features a method of calculating a path that minimizes fuel consumption and costs thereof. In preferred embodiments, the method includes forming a driving speed profile by predicting a change in driving speed and forming a path that minimizes fuel consumption and costs thereof by applying a fuel consumption cost modeling method using the driving speed profile and traffic information or the like.

### CROSS-REFERENCE TO RELATED APPLICATION

This application claims under 35 U.S.C. §119(a) the benefit of Korean patent application number 10-2009-0104910, filed on Nov. 2, 2009, which is incorporated by reference in its entirety herein.

### BACKGROUND OF THE INVENTION

The present invention relates, generally, to a method of calculating a path of a vehicle. More particularly, the present invention is directed to methods of calculating a path of a vehicle that minimizes fuel consumption and costs thereof.

Generally, an existing navigation device internally stores map data, calculates the shortest distance between the starting point and the destination and gives directions to the destination.

However, such a method of finding a path does not consider information on the current traffic situation, so that, even though the distance shown on the map is short, it may take longer in time than other paths depending on the traffic situation.

Among such navigation devices, a car navigation guidance system calculates a path to guide a car to the destination where a driver desires to go, and provides driving instructions to the driver in consideration of the current location and driving direction of the car so that the car can be driven according to the calculated path. A general car navigation guidance system is classified according to the device, independent of the path search and service provision and the time point comprising the guide information.

The method classified by a path search may include various information like real-time traffic information in selecting a path, and although it is assumed that traffic information is included, there is a long-term information-update cycle, for example like a map update, so that only long-term statistical information is suitably accepted. However, when compared with a temporary information collection error that can be generated when providing information in real time, an error rate in the case of using long-term statistical data may be different assuming a general situation.

Further, the car navigation guidance system predicts trip time using real-time information from traffic situations or long-term statistical data, and suitably adjusts the trip time in real time.

Likewise, a path search of the car navigation guidance system calculates a path which passes two points and a plurality of points designated between the two points, and the searched path is a reference path to the destination. Accordingly, the calculated path may be neither the shortest path nor a road where the traffic flow is good, or a user may have a different opinion on the path. That is, the distance of the first path, the shortest trip time first path or the expressway first path may not necessarily be the path with good mileage.

Typically, technologies, such as a method of calculating costs by mapping simple passing speed to fuel consumption tables based on constant speed driving, a method of calculating costs by considering map information, but not accurately applying fuel consumption factors, and a method of predicting fuel consumption only based on the difference in topographic altitude, have been applied.

Further, in typical technologies, practical fuel consumption prediction and cost calculation based on real-time traffic information by analyzing and applying fuel consumption factors are not possible.

Accordingly, there remains a need in the art for methods of calculating a path that minimizes fuel consumption and costs thereof.

The above information disclosed in this the Background section is only for enhancement of understanding of the background of the invention and therefore it may contain information that does not form the prior art that is already known in this country to a person of ordinary skill in the art.

### SUMMARY OF THE INVENTION

The present invention provides a method of calculating a path that minimizes fuel consumption and costs thereof.

In accordance with preferred aspects of the present invention, a method of calculating a path that minimizes fuel consumption and costs thereof includes suitably forming a driving speed profile by predicting a change in driving speed; and suitably forming a path that minimizes fuel consumption and costs thereof by applying a fuel consumption cost modeling method using the driving speed profile and traffic information or the like.

According to preferred embodiments of the present invention, preferably, the fuel consumption cost modeling method includes a fuel consumption factor and a fuel consumption element. In preferred embodiments, the fuel consumption factor is suitably determined in consideration of road, traffic, driving characteristics, free driving, traffic light, tollgate, steel sheet, and unpaved road. According to further preferred embodiments, the fuel consumption element is suitably determined in consideration of constant speed, acceleration, deceleration, stop, slide on unpaved road, change of altitude, and change of shift section.

Preferably, in preferred embodiments, in forming a path and a cost that minimize fuel consumption, after a mathematical modeling is suitably performed with a shift cause point as a sub-node and a sub-link, and mileage is suitably calculated according to the driving speed by distributing loss sections by fuel consumption factor.

Preferably, in further preferred embodiments, the sub-node is a shift point which determines characteristics of driving speed of a path due to driving speed limiting factors, such as a traffic light, a tollgate and a speed bump. Preferably, the sub-link includes a path between the sub-nodes which are adjacent. The path includes a free driving section and a restrained driving section. The free driving section is an area where driving at normal average speed (Vma) of the sub-link is possible after passing the sub-node. Preferably, the restrained driving section is an area where driving is suitably restrained or a driving pattern is suitably determined by characteristics of the sub-node.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given hereinafter by way of illustration only, and thus are not limitative of the present invention, and wherein:

FIG. 1 illustrates a speed profile according to preferred embodiments of the present invention;

FIG. 2 illustrates a fuel consumption calculation structure for each fuel consumption factor and each fuel consumption element according to the preferred embodiments of the present invention;

FIG. 3 illustrates a method of calculating a fuel consumption according to preferred embodiments of the present invention; and

FIG. 4 is a flowchart illustrating a method of calculating fuel consumption costs according to preferred embodiments of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION OF THE EMBODIMENTS

In preferred aspects as described herein, the present invention features a method of calculating a path and a cost that minimize fuel consumption, the method comprising forming a driving speed profile by predicting a change of driving speed, and calculating a path and a cost that minimize fuel consumption by applying a fuel consumption cost modeling method using the driving speed profile and traffic information.

Hereinafter, exemplary embodiments of the present invention will be described in detail with reference to the attached drawings.

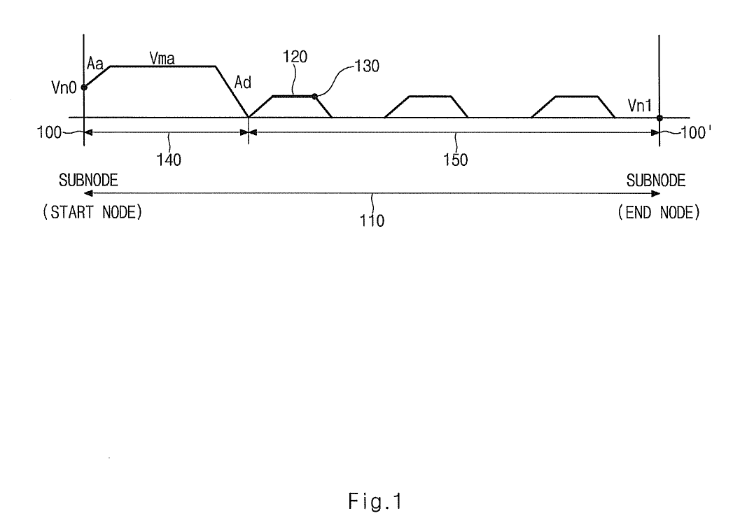

FIG. 1 illustrates a speed profile modeling according preferred embodiments of the present invention.

Referring to FIG. 1, a configuration for defining a shape for a speed profile preferably includes a sub-node 100, a sub-link 110, a v-line 120, a v-point 130, a free drive section 140 and a constrained drive section 150.

In certain exemplary embodiments, the sub-node 100 preferably refers to a shift point which suitably determines the characteristics of driving speed of the previous path by a portion which limits driving speed, such as, but not limited only to, a traffic light, a tollgate and a speed bump. In particular preferred embodiments, the sub-node 100 suitably determines a basic shape of a speed profile.

According to further embodiments of the present invention, the sub-link 110 refers to a path between adjacent sub-nodes 100. Preferably, the sub-link 110 constitutes the basic unit of the speed profile, and the section between the start sub-node 100 and the end sub-node 100 is called a sub-link 110.

In further preferred embodiments, the v-line 120 is an element of speed profile, and preferably refers to one of acceleration, constant speed and deceleration. In addition, the v-point 130 refers to a connection point of the v-line 120.

According to further preferred embodiments, the free drive section 140 refers to an area where it is possible to drive at normal average speed (Vma) of a corresponding sub-link 100 after passing the start sub-node 100.

Preferably, the constrained drive section 150 refers to an area where driving is suitably restrained or a driving pattern is suitably determined by the characteristics of the sub-node 100.

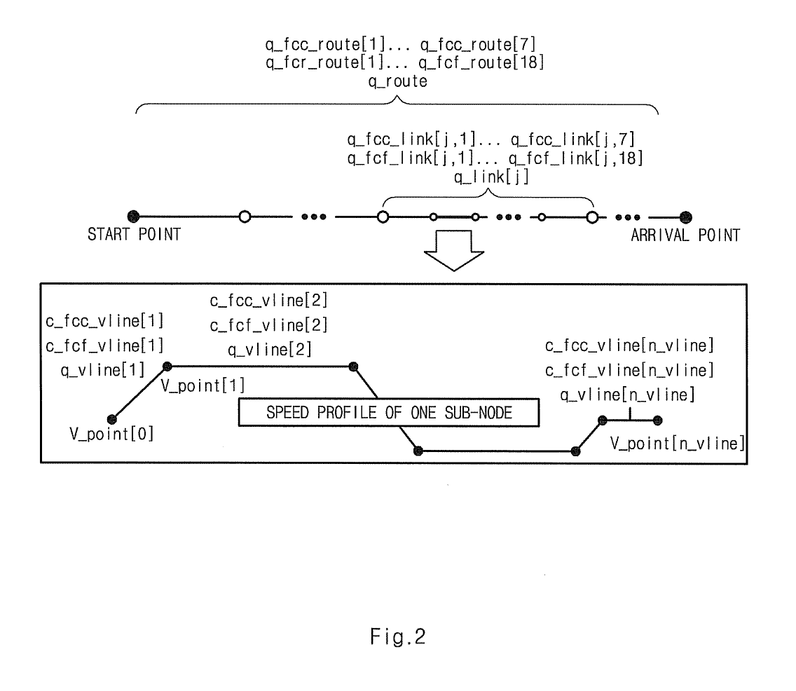

According to certain preferred embodiments and as shown in FIG. 2, FIG. 2 illustrates a fuel consumption calculation structure for each fuel consumption factor and each fuel consumption element.

Referring to FIG. 2, for example, the fuel consumption factors are suitably determined in consideration of, for example, a road, traffic, driving characteristics, general free driving, a traffic light, a tollgate, steel sheets and an unpaved road or the like.

Preferably, the fuel consumption elements are suitably designated in each v-line by modeling or measuring constant speed, acceleration, deceleration (braking), stop, a slide on an unpaved road, a change in altitude, and a change in shift section or the like.

Here, according to further preferred embodiments, the total fuel consumption is the sum of fuel consumption factors or the sum of fuel consumption elements. Preferably, the fuel consumption of each sub-link is the same as the sum of fuel consumption factors of each sub-link or the sum of fuel consumption elements of each sub-link.

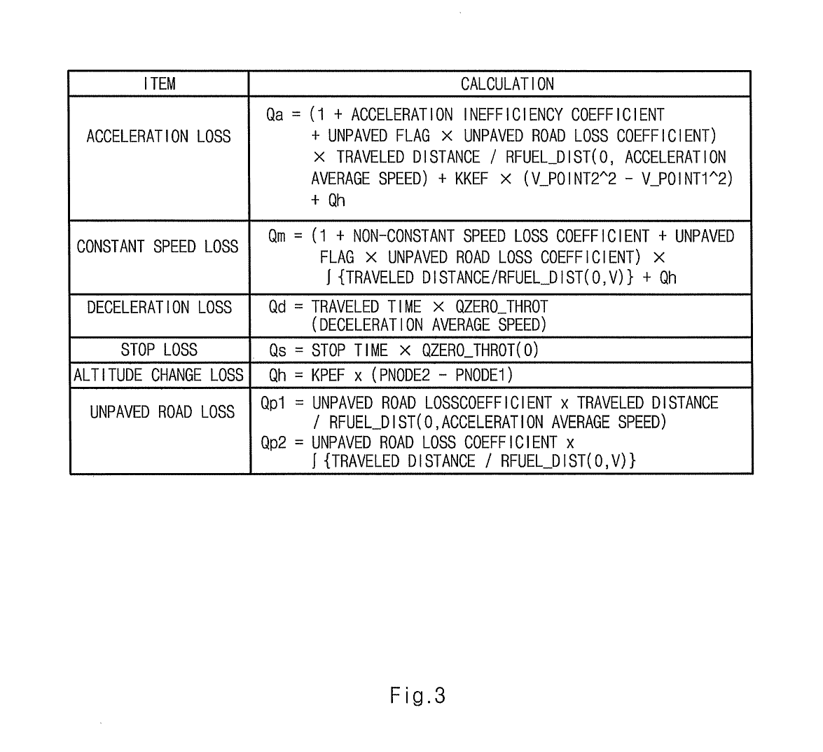

According to further preferred embodiments and as shown in FIG. 3, for example, FIG. 3 illustrates a method of calculating fuel consumption according to the present invention.

Referring to FIG. 3, for example, fuel consumption preferably includes acceleration loss, constant speed loss, deceleration loss, stop loss, altitude change loss and unpaved road loss.

In preferred exemplary embodiments, the acceleration loss (Qa) can be calculated by Qa=(1+acceleration inefficiency coefficient+unpaved flag×unpaved road loss coefficient)×traveled distance/Rfuel_dist(0, acceleration average speed)+Kkef×(V_point2̂2−V_point1̂2)+Qh. Accordingly, the acceleration inefficiency coefficient is the rate of additional fuel that is generated by incomplete combustion when accelerated.

According to further exemplary embodiments, the constant speed loss (Qm) can be calculated by Qm=(1+non-constant speed loss coefficient+unpaved flag×unpaved road loss coefficient)×∫{traveled distance/Rfuel_dist(O,V)}+Qh. Accordingly, the non-constant speed loss coefficient is fuel loss by temporary acceleration and deceleration which is suitably generated by uneven surrounding situations in normal driving state.

According to further preferred exemplary embodiments, the deceleration loss (Qd) can be calculated by Qd=traveled time×Qzero_throt (deceleration average speed).

Preferably, in certain exemplary embodiments, the stop loss (Qs) can be calculated by Qs=stop time×Qzero_throt(0).

Preferably, in further exemplary embodiments, the altitude change loss (Qh) can be calculated by Qh=Kpef×(Pnode2−Pnode1), and the unpaved road loss (Qp1,Qp2) can be calculated by Qp1=unpaved road loss coefficient×traveled distance/Rfuel_dist(0, acceleration average speed) and Qp2=unpaved road loss coefficient×∫{traveled distance/Rfuel_dist(0,V)}. At this time, the methods of calculating altitude change loss (Qh) and unpaved road loss (Qp1, Qp2) are added to acceleration loss (Qa) and constant speed loss (Qm), and are not added to deceleration loss (Qd) and stop loss (Qs).

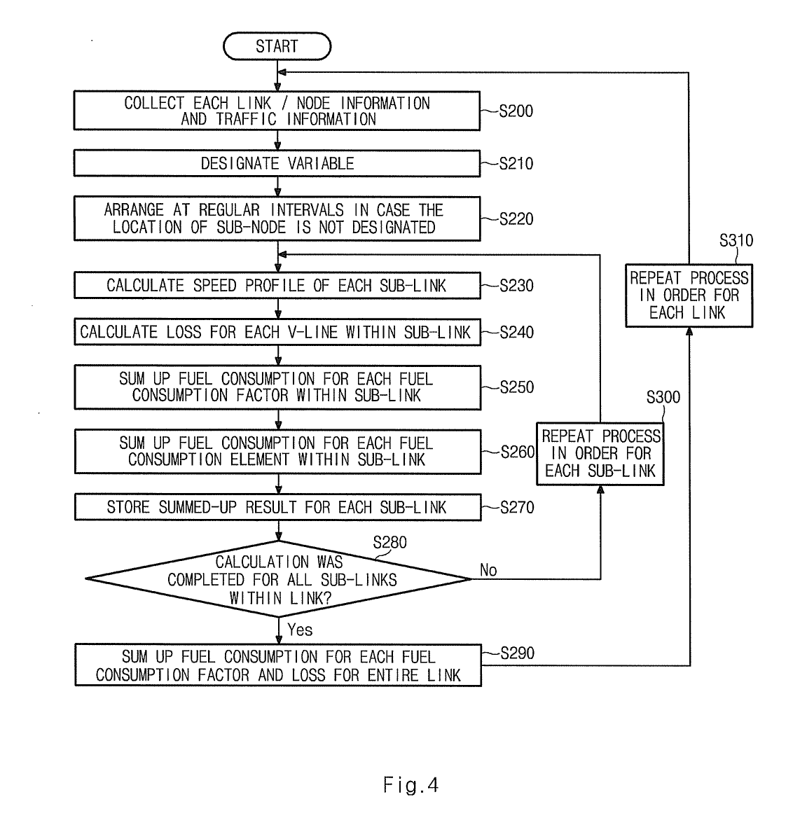

According to further preferred embodiments and as shown in FIG. 4, for example, FIG. 4 is a flowchart illustrating a method of calculating fuel consumption costs.

Referring to FIG. 4, for example, each link/node information and traffic information is suitably collected (S200). Preferably, input data processing for each link includes suitably inputting link and node attributes data from map data, inputting data of an unmanned monitoring camera, or suitably inputting real-time traffic information from TEPG.

Preferably, after collecting each link/node information and traffic information, a variable is designated (S210). Accordingly, the variable generates a map constant, a car information constant, and a speed profile constant.

Preferably, after designating a variable, in case the positions of sub-nodes are not suitably designated, the positions of the nodes are suitably adjusted to be located at regular intervals (S220).

According to further preferred embodiments of the present invention, in case the positions of sub-nodes are not suitably designated, after adjusting the positions of the nodes to be located at regular intervals, speed profile of each sub-link is calculated, and loss by v-line within the sub-link is suitably calculated (S230).

In further preferred embodiments, fuel consumption for each fuel consumption factor and fuel consumption for each fuel consumption element are suitably summed up within the sub-link (S240). Preferably, the class value for fuel consumption elements of each v-line is suitably generated, and acceleration, constant speed, deceleration and stop values are also suitably generated.

In further preferred embodiments, after summing up fuel consumption for each fuel consumption factor and fuel consumption for each fuel consumption element, the summed-up result for each sub-link is suitably stored (S250 to S270). Thereafter, it is suitably determined whether calculation for all sub-links within the link is completed (S280).

Preferably, according to further preferred embodiments, after calculation for all sub-links within the link is suitably completed, fuel consumption for each fuel consumption factor and loss is suitably summed up for the entire link (S290). However, if calculation for the sub-links within the link is not suitably completed, the process of recalculating the speed profile for each sub-link is performed again (S300).

Accordingly, in further exemplary embodiments, after summing up fuel consumption for each fuel consumption factor and loss for the entire link, the process is repeated for each link (S310).

As described herein, the present invention calculates direct driving speed profile of acceleration, constant speed, deceleration and stop by predicting a change in driving speed in each link, and suitably establishes a fuel consumption model using traffic information or the like, thereby providing a method of searching a path that minimizes fuel consumption and a technology that calculates fuel consumption.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method of calculating a path and a cost that minimize fuel consumption, the method comprising:
forming a driving speed profile by predicting a change of driving speed; and
calculating a path and a cost that minimize fuel consumption by applying a fuel consumption cost modeling method using the driving speed profile and traffic information.

2. The method of claim 1, wherein the fuel consumption cost modeling method comprises a fuel consumption factor and a fuel consumption element.

3. The method of claim 2, wherein the fuel consumption factor is determined using one or more parameters selected from the group consisting of: road, traffic, driving characteristics, free driving, traffic light, tollgate, steel sheet, and unpaved road.

4. The method of claim 2, wherein the fuel consumption element is determined using one or more parameters selected from the group consisting of: constant speed, acceleration, deceleration, stop, slide on unpaved road, change of altitude, and change of shift section.

5. The method of claim 1, wherein, in forming a path and a cost that minimize fuel consumption, after a mathematical modeling is performed with a shift cause point as a sub-node and a sub-link, mileage is calculated according to the driving speed by distributing loss sections by fuel consumption factor.

6. The method of claim 5, wherein the sub-node is a shift point, and wherein the shift point determines characteristics of driving speed of a path due to driving speed limiting factors.

7. The method of claim 5, wherein the sub-link comprises a path between the sub-nodes, wherein the sub-nodes are adjacent.

8. The method of claim 5, wherein the path includes a free driving section and a restrained driving section.

9. The method of claim 8, wherein the free driving section is an area where driving at normal average speed (Vma) of the sub-link is possible after passing the sub-node.

10. The method of claim 8, wherein the restrained driving section is an area where driving is restrained or a driving pattern is determined by characteristics of the sub-node.
